(19) United States
(12) Patent Application Publication
(10) Pub. No.: US 2026/0368433 A1
(43) Pub. Date: Nov. 19, 2026

(54) INTENT-BASED TEXT CLUSTERING VIA SUMMARIZATION

(71) Applicant: GOOGLE LLC, Mountain View, CA (US)

(72) Inventors: Joseph Turner, San Mateo, CA (US); Joseph Chen, Bothell, WA (US)

(21) Appl. No.: 19/206,934

(22) Filed: May 13, 2025

(51) Int. Cl. G06F 40/30; G06F 11/07; G06F 16/35

(52) U.S. Cl. CPC G06F 40/30; G06F 11/0706; G06F 11/0793; G06F 16/35

(57) ABSTRACT

Techniques are described herein for processing each of multiple text segment using a machine learning model to generate summarized versions thereof. A semantic similarity measure is then calculated between pairs of summarized text segments using the machine learning model or an additional machine learning model. Based on these similarity measures, a cluster of summarized text segments is determined to be formed. In response to determining that the cluster is formed, one or more automated actions are performed. The automated actions that are performed can optionally be particularized to summarized text segments, text segments, and/or metadata that corresponds to the determined cluster.

### BACKGROUND

Determining that multiple disparate instances of text segments are semantically similar to one another can be beneficial in many situations. For example, assume a bug is present in an application and twenty different users provide, via respective client devices, respective instances of natural language feedback regarding the bug. Determining that the twenty instances of natural language feedback are all describing the same bug, as opposed to each describing a different one of twenty different bugs, can be beneficial in prioritizing the bug and/or in triaging the bug.

Various techniques have been proposed for processing two or more text segments to determine whether they are semantically similar to one another. However, such techniques can suffer from one or more drawbacks. As one example, such techniques can have high occurrence of false negatives (i.e., when semantically similar text segments are erroneously determined not to be semantically similar) and/or high occurrence of false positives (i.e., when semantically dissimilar text segments are erroneously determined to be semantically similar). For instance, some techniques often focus on linguistic similarities between text segments, which can result in high occurrence of false negatives when compared text segments differ significantly in length, phrasing, and/or tone - despite being semantically similar to one another. As another example, such techniques can additionally and/or alternatively fail to account for metadata, that is in addition to the text segments themselves, in determining whether text segments are semantically similar.

Additional and/or alternative drawbacks of these and/or other techniques may be presented.

### SUMMARY

Implementations disclosed herein are directed to techniques for automatic, robust, and accurate determination that multiple text segments are semantically similar to one another and, in response, causing performance of automated action(s) that are based on the text segments determined to be semantically similar to one another. The automated action(s) can include, for example, generation and/or transmission of message(s) that are based on the text segments, disabling of application feature(s) that correspond to the text segments, rolling back application update(s) that correspond to the text segments, and/or causing prioritization of remediating action(s) that correspond to the text segments. More generally, various implementations are directed to improving accuracy and/or robustness of similarity analysis and clustering of text segments, especially when those text segments exhibit differences in phrasing, wording, grammar, and/or overall voice, despite describing the same underlying concept or event.

Accordingly, implementations disclosed herein accurately and/or robustly determine that multiple text segments are semantically similar to one another and, in response, can cause performance of one or more automated actions that are based on the text segments. In these and other manners, the automated action(s) can be performed in an accurate and efficient manner. This can prevent computationally burdensome occurrences of performance of the automated action(s) in false positive situations (i.e., situations in which semantically dissimilar text segments are erroneously determined to be semantically similar) and/or occurrences of non-performance of the automated action(s) in false negative situations (i.e., situations in which semantically similar text segments are erroneously determined not to be semantically similar). Put another way, implementations herein can ensure that the automated action(s) are performed when they are indeed warranted, which can cause improvements to (e.g., address bug(s) with) underlying application(s) and/or systems - while also avoiding computationally burdensome occurrences of performance of unnecessary automated action(s).

Various implementations disclosed herein process, using a machine learning model, a first text segment to generate a summarized first text segment that is shortened relative to the first text segment and process, using the machine learning model, a second text segment to generate a summarized second text segment that is shortened relative to the second text segment. For example, the machine learning model can be a generative model (e.g., a large language model (LLM)) that is fine-tuned to generate summarized versions of raw text segments, and each summarized text segment can be generated based on processing, using the generative model, a prompt that includes a corresponding raw text segment. As another example, each summarized text segment can be generated based on processing, using a generative model (e.g., one not fine-tuned to generate summarized versions of raw text segment), a prompt that includes a corresponding raw text segment and that includes instructional language that requests summarization to a given degree and/or in a given voice or tone. For instance, the prompt can be of the form “Generate an about 10 word summary of the following text segment in the tone of an experienced software engineer and be sure the summary maintains key information from the text segment: [text segment]”.

After generating the summarized first text segment and the summarized second text segment, both are processed, using a machine learning model, to generate a semantic similarity measure. The semantic similarity measure reflects a magnitude of semantic similarity between the summarized first text segment and the summarized second text segment. Implementations disclosed herein recognize that processing the summarized first text segment and the summarized second text segment in generating the semantic similarity measure can result in more accurate semantic similarity measures than if the first text segment and the second text segment are processed without any processing of the summarized versions thereof. As one example of generating the semantic similarity measure, a similarity prompt can be generated that includes the summarized first text segment, the summarized second text segment, and instructional language that requests determination of a magnitude of semantic similarity between the summarized first text segment and the summarized second text segment. Further, the similarity prompt can be processed using a generative model to generate output that reflects the semantic similarity measure. For instance, the similarity prompt can be of the form “provide a value from 1 to 10 that reflects a degree of similarity between the following two text segments, with 1 indicating least amount of similarity and 10 indicating greatest amount of similarity: 1st segment=[first summarized text segment]; 2nd segment =[second summarized text segment]”. A generative model utilized to generate the semantic similarity measure can be the same as, or can differ from, any generative model utilized to generate the summarized text segments. As another example, a non-generative model, such as a feed-forward machine learning model trained for semantic similarity measure generation, can be used to process the summarized first text segment and the summarized second text segment (e.g., tokens thereof or embeddings thereof).

As described herein, metadata corresponding to a pair of summarized text segments can additionally be utilized in generating a semantic similarity measure for the pair. For example, the metadata can be included as part of a similarity prompt processed in generating a semantic similarity measure or the metadata can be used to modify (e.g., increase or decrease) a similarity measure generated based on a similarity prompt. Metadata for a summarized text segment can include metadata corresponding to submission of a text segment on which the summarized text segment is generated. For example, the metadata for a summarized text segment can include a temporal attribute of the submission of the corresponding text segment (e.g., date and/or time of submission), a geographical attribute of the submission (e.g., a region, state, or city of submission), and/or a version of an application to which the submission is directed (e.g., when the submission is feedback on an application, a version of the application). For instance, assume metadata includes a corresponding temporal attribute for each summarized text segment of a pair. If the corresponding temporal attributes are included as part of a similarity prompt for the pair, a generated semantic similarity measure will be more indicative of similarity when the corresponding temporal attributes are close to one another (e.g., within 24 hours of one another) than when the corresponding temporal attributes are further away from one another (e.g., greater than 1 week apart). If the corresponding temporal attributes are used to boost or demote a determined semantic similarity measure, the magnitude of boosting or demotion can be based on the difference between the corresponding temporal attributes. For instance, the semantic similarity score can be boosted ten percent if the difference is less than 24 hours, can be boosted five percent if the difference is between 24 and 72 hours, and can be demoted five percent if the difference is greater than 168 hours.

The generated semantic similarity measure, for a pair of summarized text segments, can be used to determine whether the pair of summarized text segments are part of a cluster of summarized text segments that are all semantically similar to one another. For example, the pair can be included in a cluster with one another in response to the semantic similarity measure indicating a high degree of similarity. Further, additional summarized text segment(s) can be included in the cluster, along with the pair of summarized text segments, based on semantic similarity measure(s) between the additional summarized text segment(s) and summarized text segment(s) of the pair and/or other of the additional summarized text segment(s).

In response to determining that a cluster is formed by a set of summarized text segments, performance of one or more automated actions can be caused - such as one or more of the automated actions described herein. For example, an automated action can include transmitting a message to endpoint(s), such as transmitting email(s) to email address(es), text message(s) to phone number(s), and/or chat message(s) to username(s). For instance, the message can include the summarized text segments or an overall summary of the summarized text segments and optionally of metadata of the summarized text segments, such as an overall summary generated based on prompting a generative model to summarize all of the summarized text segments of the cluster. In some implementations, the endpoint(s) to which the message(s) are sent can be selected based on the summarized text segments of the cluster and/or metadata of the summarized text segments. For example, assume first endpoint(s) are defined for addressing issues with a first feature of an application and second endpoint(s) are defined for addressing issues with a second feature of an application. To determine to which endpoint(s) the message(s) should be sent, a prompt can be generated that is of the form “do the following text segments relate more closely to first feature or to second feature: [text segments of cluster]”, that prompt processed using a generative model, and corresponding output utilized in determining whether to send the message(s) to the first endpoint(s) or the second endpoint(s). As another example, the automated action(s) can include rolling back an update to an application and/or preventing further updates to the application. For example, such automated action(s) can be caused to be performed in response to determining that the text segments of a cluster all relate to the update and/or have metadata reflecting a version of the application that corresponds to the update.

As a non-limiting example, assume there are thousands of text segments that are each a corresponding instance of feedback regarding an application. Summarized versions of each of the thousands of text segments can be generated. Further, a corresponding semantic similarity measure can be generated for each pairwise combination of the summarized versions of the text segments. Yet further, a graph can be constructed that includes a corresponding node for each of the summarized versions of the text segments and that includes an edge between each pair of nodes, where each edge corresponds to a corresponding semantic similarity measure. For instance, if node 1 represents a first summarized text segment and node 2 represents a second summarized text segment, the edge between node 1 and node 2 can reflect the semantic similarity measure between the first summarized text segment and the second summarized text segment. Likewise, if node 3 represents a third summarized text segment, the edge between node 1 and node 3 can reflect the semantic similarity measure between the first summarized text segment and the third summarized text segment. An automatic clustering algorithm, such as affinity propagation or K-means clustering, can be applied to the graph to determine cluster(s) of node(s) in the graph. Automated action(s) can then be caused to be performed based on the determined cluster(s). As described herein, the automated action(s) caused to be performed based on a cluster can optionally be particularized to summarized text segment(s) corresponding to the node(s) of the cluster and/or to metadata corresponding to the node(s) of the cluster.

As another non-limiting example of some implementations disclosed herein, consider a mobile mapping application receiving user feedback reports. Each report describes a problem encountered while using the application’s navigation feature. These reports, however, vary significantly in style and wording due to the diverse backgrounds and writing styles of the users. The system processes each report (each being a corresponding text segment) using an LLM to generate a corresponding concise summary (each being a corresponding summarized text segment). These summaries, while significantly shorter than the original reports, retain the core semantic meanings of the original reports. Pairs of these summaries are then processed, using a machine learning model (e.g., the LLM or an additional machine learning model), to generate a corresponding semantic similarity score for each pair. A clustering algorithm (e.g., affinity propagation) is applied to the resulting similarity scores, grouping summaries describing similar issues into clusters. If a cluster exceeds a threshold (e.g., 50 reports), indicating a widespread problem, the system automatically generates a concise summary of the cluster, which is then sent to the engineering team responsible for the navigation feature, triggering a review and potential bug fix. Implementations can also automatically prioritize this bug report based on the size of the cluster (e.g., number of nodes in the cluster) and/or urgency of the problem reflected by the nodes of the cluster.

As another non-limiting example of some implementations disclosed herein, imagine a scenario where a customer support team receives numerous customer reviews and feedback regarding a specific product feature. These reviews are diverse, coming from different users with varying writing styles and levels of technical expertise. Some reviews may be very detailed, while others are brief and use colloquial language. Implementing the disclosed techniques, the system first summarizes each review using a fine-tuned LLM to create concise, standardized summaries, each approximately 15 words in length and written in a neutral, objective tone. These summaries capture the key points of each review, focusing on the customer’s specific issue or sentiment. Next, the system compares pairs of summaries using a machine learning model, generating a similarity score for each pair. The similarity scores are then used to build a graph, where each node represents a summary and each edge represents the similarity score between two summaries. A clustering algorithm, such as K-means or EM clustering, is applied to this graph to group similar reviews into clusters. For instance, a cluster might emerge containing reviews from multiple users all expressing difficulty using a new feature introduced in the latest product update. In response to detecting this cluster, the system automatically halts any further implementations of the latest product update and/or rolls back existing implementations of the latest product update.

As another practical example, consider a type of robot b where customers frequently submit feedback through various channels, such as online surveys, support tickets, and social media. A new software update is rolled out to improve the robot’s navigation capabilities. Post-update, a surge of negative feedback emerges, all related to the robot’s performance. One customer writes, “The robot keeps bumping into furniture after the update,” while another reports, “Navigation is worse than before; it gets stuck in corners.” A third simply states, “The robot is now completely useless.” Using the disclosed method, each piece of feedback is first summarized using a generative model, resulting in concise summaries capturing the essence of the issues raised. These summaries are then compared, and a graph is constructed based on their semantic similarity. If the algorithm identifies a cluster of feedback all reporting similar navigation problems post-update, the system could trigger an automated action such as halting the update’s further rollout or notifying the robot’s developers of a critical navigation issue. This proactive approach prevents the problem from affecting more users and accelerates the debugging process, all while using the semantic analysis of the robot user’s feedback data.

The preceding is provided as an overview of some implementations disclosed herein. Those implementations and other implementations will be discussed in more detail below.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include a client device that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

### BRIEF DESCRIPTION OF THE DRAWINGS

FIG. 1 schematically depicts an example environment in which disclosed techniques may be employed, in accordance with various implementations.

FIG. 2 depicts an example method for practicing selected aspects of the present disclosure.

FIGS. 3A, 3B, and 3C depict an example demonstrating various aspects of the present disclosure.

FIG. 4 depicts an example of processing data, related to a determined cluster, in determining automated action(s) to cause performance of.

FIG. 5 schematically depicts an example architecture of a computer system.

### DETAILED DESCRIPTION

Implementations described herein relate to determining that multiple disparate text segments each describe the same concept or event, despite those disparate text segments having different wording, different writing styles, and/or otherwise linguistically differing from one another. In some implementations, one or more actions may be performed in response to determining that multiple disparate text segments each describe the same concept or event. For example, if more than a threshold quantity of text segments are determined to describe an issue with an aspect of a computer application, notification(s) can be sent to endpoint(s) that are assigned to that aspect, that aspect can be temporarily disabled or limited, recent update(s) applied to that aspect can be rolled back, and/or other automated action(s) can be performed.

Various implementations describe a method for improving the accuracy of similarity analysis and clustering of text segments, particularly when those segments exhibit differences in phrasing, wording, grammar, and overall voice, despite describing the same underlying concept or event. Existing techniques often rely heavily on linguistic similarity, leading to inaccurate results when semantically similar texts differ significantly in their surface-level characteristics.

Implementations disclosed herein address these and other limitations by employing a multi-stage process in performing similarity analysis of text segments. First, each raw text segment is summarized using a generative model, such as a large language model (LLM) or other generative model prompted to produce summaries of a consistent length (X) and tone (e.g., “academic researcher tone”). This summarization step standardizes the linguistic features of the input texts, mitigating the impact of variations in voice and style. The summarization process may involve fine-tuning a model for this specific task, training it on pairs of original and summarized text, or using a general model with a carefully crafted prompt specifying the desired length and tone. Fine-tuning provides a model trained specifically for this summarization task, while prompting a generic model allows for flexibility and avoids the need for extensive training data. Second, a similarity measure is computed between pairs of these summarized text segments using another ML model, which may be fine-tuned or prompted with a carefully crafted prompt. This similarity measure can be generated based solely on processing the textual content of the summarized text segments or can additionally be generated based on metadata, such as timestamps (e.g., with percentage adjustments to the similarity score based on time differences, e.g., +20% for timestamps within 6 hours, +10% for timestamps within 12 hours, -10% for timestamps over 24 hours apart), geographic location (e.g., +20% if from the same region), and/or application version (e.g., +10% if same application version).

The similarity scores are then used to construct a graph where nodes represent summarized text segments and edges represent similarity measures. Clustering algorithms, such as K-means clustering, EM clustering, or affinity propagation, are applied to this graph to identify clusters of semantically similar text segments. Affinity propagation can be advantageous as it does not require pre-defining the number of clusters (K), unlike K-means clustering. The heuristic for determining “similar enough” summaries to be grouped into clusters can be based on the weights of the edges in the graph, with clusters being identified using one or more automated clustering techniques. The identified clusters can then trigger automated action(s), such as notifying relevant personnel, rolling back updates, prioritizing bug fixes, and/or disabling or limiting application aspects, optionally depending on the semantic meaning of the cluster and/or depending on other feature(s) of the cluster. The semantic meaning of a cluster can be determined by processing the cluster’s summarized text segments using an LLM or other generative model prompted to identify area(s) of concern or other topic(s) reflected by the cluster (e.g., “identify the main area(s) of concern reflected by the following text segments: [text segments]”). The graph can be updated over time. For example, as new text segments arrive, they are summarized, compared to existing nodes in the graph, and added as new nodes with edges representing the similarity measures to the existing nodes. The clustering algorithm then re-evaluates the clusters based on the updated graph. For example, the clusters can be re-evaluated any time a new node is added, when a threshold quantity of new nodes are added, hourly, daily, or at other regular or non-regular intervals. These approaches allow for the identification of semantic similarity that might be missed by traditional methods that rely solely on linguistic features, enabling more accurate clustering and more effective responses to user feedback or other text-based data streams.

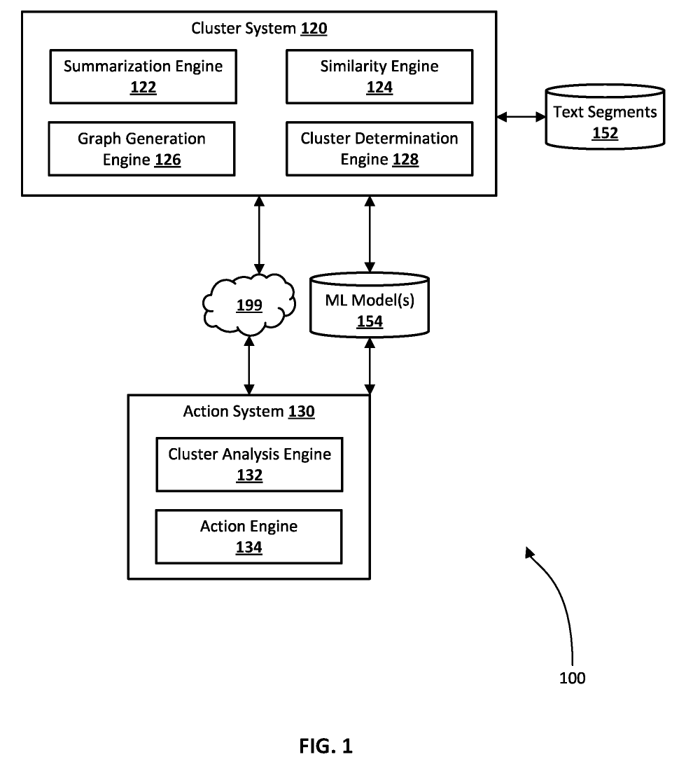

Turning now to FIG. 1, a block diagram is shown of an example environment 100 in which various implementations disclosed herein may be implemented. The example environment 100 includes a cluster system 120, an action system 130, a text segments database 152, and machine learning model(s) 154. Although illustrated as separate systems connected by a network 199, cluster system 120 and action system 130 may be implemented as part of the same system in various implementations. Further, the cluster system 120 and action system 130 can include one or more memories for storage of data and/or software applications, one or more processors for accessing data and executing the software applications, and/or other components that facilitate communication over one or more of the networks 199. In some implementations, the one or more networks 199 could be or include a wired and/or wireless network. Examples of such networks can include one or more wired or wireless local area networks (“LANs,” including Wi-Fi LANs, mesh networks, near-field communication, etc.) or wide area networks (“WANs”, including the Internet).

The cluster system 120 is illustrated as including a summarization engine 122, a similarity engine 124, a graph generation engine 126, and a cluster determination engine 128.

The summarization engine 122 can retrieve text segments from the text segments database 152 and process each text segment to generate a corresponding summarized text segment. The text segments stored in the text segments database 152 can be various types of text segments, such as text segments that are generated via corresponding instances of user interface input at corresponding client devices. For example, the text segments database 152 can store text segments that are each a corresponding instance of natural language feedback that is based on corresponding user interface input (e.g., typed or spoken) at a corresponding client device. Some or all of the text segments of the text segments database 152 can be stored in association with corresponding metadata (also stored in the text segments database 152 or elsewhere). For example, when the text segments are each based on a corresponding submission of a corresponding instance of user interface input, the corresponding metadata for a submission can include temporal metadata that is indicative of a time of the submission, version metadata that is indicative of a version of an application to which the submission is directed, geographic metadata that is indicative of a geographic region from which the submission is provided, and/or other metadata.

The summarization engine 122 can process each text segment to generate a corresponding summarized text segment using various techniques. In some implementations, the summarization engine 122 can utilize machine learning model(s) 154 in generating a summarized text segment based on a corresponding text segment. For example, the machine learning model(s) 154 can include a generative model, such as large language model (LLM), fine-tuned for use in generating summarized text segments that are of approximately a given length (e.g., about 10-15 words) and/or that are of a given tone (e.g., an academic-researcher tone). For instance, the generative model can be fine-tuned for use in generating summarized text segments based on being trained using supervised examples that each include a corresponding raw text segment input and a corresponding output that is a summarized version of the corresponding raw text segment input and that is summarized to a given length and, optionally, in a given voice. As another example, the machine learning model(s) 154 can include a generative model and the summarization engine 122 can generate a summarization prompt, for processing using the generative model, that includes a text segment to be summarized and that also specifies a length of the summarization of the text segment and optionally a tone of the summarization. For example, the summarization prompt can be of the form “Generate a 10-15 word summarization of the following text segment in the tone of an academic researcher.”

The similarity engine 124 can process pairs of summarized text segments that are generated by the summarization engine 122 to generate a corresponding semantic similarity measure for each of the pairs. For example, the summarization engine 122 can generate a first, second, and third summarized text segment for a first, second, and third text segment - and the similarity engine 124 can process the first summarized text segment and the second summarized text segment to generate a first semantic similarity measure, the first summarized text segment and the third summarized text segment to generate a second semantic similarity measure, and the second summarized text segment and the third summarized text segment to generate a third semantic similarity measure.

In some implementations, the similarity engine 124 processes a pair of summarized text segments using one of the machine learning model(s) 154 in generating a semantic similarity measure for the pair. The machine learning model(s) 154 can be the same as or different from any of the machine learning model(s) 154 used by the summarization engine 122 in generating respective summarized text segments. For example, the similarity engine 124 can utilize a generative model that is fine-tuned to generate semantic similarity measures. For instance, the generative model can be fine-tuned for use in generating similarity measures based on being trained using supervised examples that each include a corresponding pair of summarized text segments input and a corresponding output that is a supervised semantic similarity measure (e.g., one assigned based on input from human reviewer(s)). As another example, the similarity engine 124 can generate a similarity prompt, for processing using a generative model, that includes a pair of summarized text segments and that optionally also includes instruction data that requests generation of semantic similarity measure output (e.g., the similarity prompt can be of the form “Generate a semantic similarity measure, to two decimal points, between the following two text segments and with 1 being most similar and 0 being least similar: [first summarized text segment]; [second summarized text segment]”.

In some implementations, the similarity engine 124 further utilizes corresponding metadata, for each of a pair of summarized text segments, in generating a semantic similarity measure based on the pair of summarized text segments. For example, the metadata can include temporal metadata, version metadata, geographic metadata, and/or other metadata of a text segment upon which generation of a corresponding summarized text segment is based. In some versions of those implementations, the similarity engine 124 can utilize the metadata to adjust an initial semantic similarity measure generated based on processing the pair of summarized text segments using a machine learning model. For example, the similarity engine 124 can boost or demote an initial semantic similarity measure for a pair of summarized text segments based on corresponding metadata for the pair. For instance, the initial semantic similarity measure can be boosted ten percent if corresponding temporal metadata for the pair indicates that corresponding submission times of text segments in the pair are within 24 hours of one another and the initial semantic similarity measure can be boosted five percent if corresponding temporal metadata for the pair indicates that corresponding submission times of text segments in the pair are between 24 and 72 hours of one another.

In some additional or alternative versions of those implementations, the similarity engine 124 can, in generating a semantic similarity measure, process corresponding metadata for a pair of summarized text segments along with processing the pair of summarized text segments. For example, the similarity engine 124 can generate a similarity prompt that includes a pair of summarized text segments, corresponding metadata for the pair of summarized text segments, and that requests generation of a semantic similarity measure based on the pair of summarized text segments and based on the corresponding metadata. For instance, the similarity prompt can be of the form “Generate a semantic similarity measure, to two decimal points, between the following two text segments and with 1 being most similar and 0 being least similar; take into account similarity between the text and similarity between the metadata for the text: [text of first summarized text segment]; [text of second summarized text segment]; [first metadata for first summarized text segment]; [second metadata for second summarized text segment]”. The similarity engine 124 can then process such a similarity prompt using a machine learning model to generate the semantic similarity measure.

The graph generation engine 126 can generate a graph based on the summarized text segments generated by the summarization engine 122 and based on the semantic similarity measures generated by the similarity engine 124. For example, the graph generation engine 126 can generate a graph that includes a corresponding node for each summarized text segment and that also includes an edge between each pair of nodes. The edge between each pair of nodes in the graph corresponds to a corresponding semantic similarity measure generated by the similarity engine 124. The cluster determination engine 128 can determine, based on the graph generated by the graph generation engine 126, one or more clusters of nodes from among the nodes of the graph. For example, the cluster determination engine 128 can determine one or more clusters of nodes from among the nodes of the graph using an affinity propagation technique, an affinity-based clustering technique, or other suitable technique.

The action system 130 is illustrated as including a cluster analysis engine 132 and an action engine 134.

The cluster analysis engine 132 can process a cluster, determined by cluster determination engine 128, to determine one or more actions, to cause performance of, that are particularized to the cluster. For example, the cluster analysis engine 132 can determine a particularized action that is particularized to summarized text segments corresponding to nodes of the cluster and/or that is particularized to metadata corresponding to those nodes. For instance, the cluster analysis engine 132 can generate a prompt based on the summarized text segments corresponding to the nodes of the cluster and/or based on the metadata corresponding the nodes of the cluster, process that prompt using a generative model of the ML model(s) 154 (which can be the same or different as any of the ML model(s) 154 utilized by the summarization engine 122 and/or by the similarity engine 124), and determine one or more particularized actions to cause performance of based on output generated by processing the prompt using the generative model.

As one example, the cluster analysis engine 132 can process a prompt that is of the form “generate a summary of the problem(s) that are reflected by the following set of text segments and their related metadata: [text segments of this cluster]; [metadata related to text segments of this cluster]”. The cluster analysis engine 132 can cause the prompt to be processed using a generative model to generate output that reflects a summary of the problem(s) that are reflected by the cluster. The cluster analysis engine 132 can then cause action(s) to be performed that are particularized to the summary of the problem(s). For example, such action(s) can include transmission of a message that includes the summary of the problems and/or transmission(s) of message(s) (that optionally includes the summary of the problems) to endpoint(s) that are defined endpoint(s) for resolution of the problems reflected by the cluster. As another example, such action(s) can include disabling of application feature(s) that correspond to the summary of the problems and/or rolling back of update(s) that correspond to the summary of the problems.

The action engine 134 can cause, based on one or more automated actions determined by the cluster analysis engine 132, performance of the action(s) determined by the cluster analysis engine 132. For example, the action engine 134 can communicate with one or more external devices and/or one or more external programs over the network 199 to cause performance of the action(s) determined by the cluster analysis engine 132. For instance, the action engine 134 can send, over the network 199, instructions to cause the generation of one or more messages, the transmission of one or more messages, and/or the performance of one or more other automated actions.

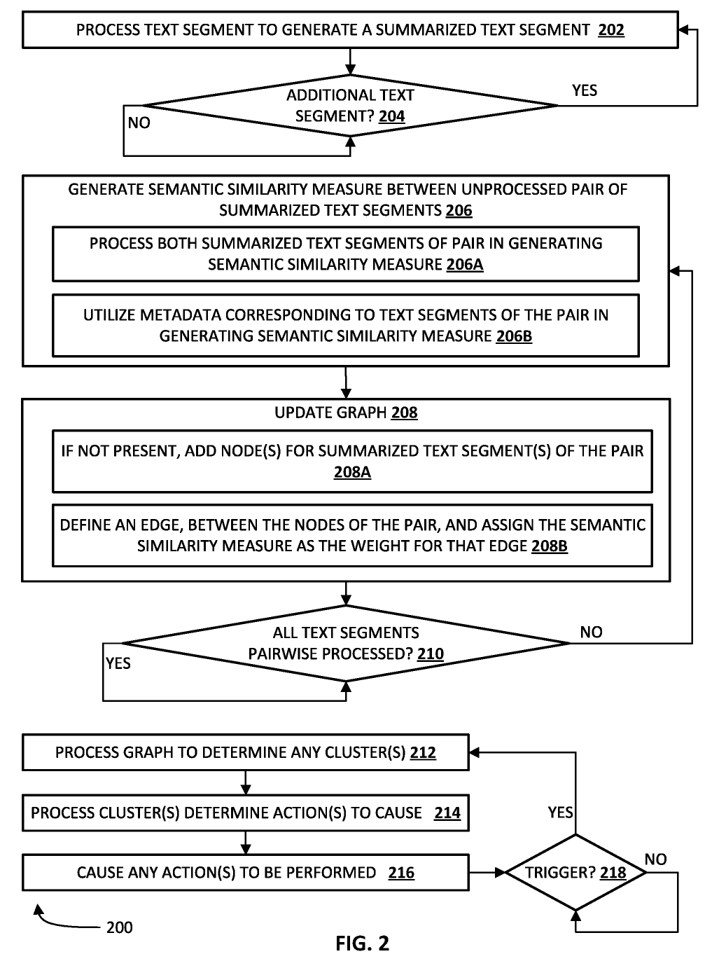

Turning now to FIG. 2, a flowchart illustrating an example method 200 for practicing selected aspects of the present disclosure is depicted. For convenience, the operations of the method 200 are described with reference to a system that performs the operations. This system of method 200 includes at least one processor, memory, and/or other component(s) of computing device(s). Moreover, while operations of the method 200 are shown in a particular order, this is not meant to be limiting. One or more operations may be reordered, omitted, and/or added.

At block 202, the system processes a text segment to generate a summarized text segment. For example, the system can generate a prompt that includes the text segment and can process the prompt using a generative model to generate output that reflects the summarized text segment. For instance, the prompt can include the text segment and instructions to summarize the text segment to a given length and/or to a given tone (e.g., “Generate a 10-15 word summary of the following text segment in the tone of an academic researcher”). As another example, the system can process the text segment to generate a summarized text segment using a machine learning model that is fine-tuned to generate summarized text segments of the given length and/or tone.

At block 204, the system determines whether there is an additional unprocessed text segment to be processed. For example, the system can make such a determination by determining whether there are any text segments stored in a text segments database (e.g., the text segments database 152) that have not yet been processed. If the system determines there are additional unprocessed text segment(s) to be processed, the system returns to block 202 and processes another text segment. If the system determines that there are no additional unprocessed text segment(s) to be processed, the system performs another iteration of block 204, optionally after a pause. For example, the system may wait for one minute, one hour, or another amount of time to pass before performing another iteration of block 204 to determine whether there are additional unprocessed text segment(s), as recently received text segments.

At block 206, the system generates a semantic similarity measure between an unprocessed pair of summarized text segments, of the summarized text segments generated at block 202. Block 206 includes sub-block 206A in which the system, in generating the similarity measure, processes each summarized text segment of the pair in generating the semantic similarity measure. For example, for a first summarized text segment and a second summarized text segment among the summarized text segments generated at block 202, the system can generate the semantic similarity measure based on processing the first summarized text segment and the second summarized text segment using a machine learning model. For instance, the system can generate a prompt that includes the first summarized text segment and the second summarized text segment and process the prompt using the machine learning model to generate output that reflects the similarity measure. As one example, the prompt can be of the form “generate a semantic similarity measure, between the following two text segments and to 2 decimal points: [first summarized text segment]; [second summarized text segment]”.

Block 206 optionally further includes sub-block 206B in which the system utilizes metadata corresponding to the pair of summarized text segments in generating the semantic similarity measure. The metadata for a text segment can include, for example, temporal metadata, version metadata, geographic metadata, and/or other metadata of a text segment upon which generation of a corresponding summarized text segment is based.

For example, at sub-block 206B the system can utilize the metadata to adjust an initial semantic similarity measure generated based on processing the pair of summarized text segments using a machine learning model. For instance, the initial semantic similarity measure can be boosted five percent if corresponding version metadata for the pair indicates that corresponding applications version upon which the text segments are based is the same version and the initial semantic similarity measure decreased five percent if corresponding version metadata for the pair indicates that corresponding version for the text segments are not the same.

In some additional or alternative versions of those implementations, the system can, in generating a semantic similarity measure at sub-block 206B, process corresponding metadata for a pair of summarized text segments along with processing the pair of summarized text segments. For example, the system can generate a prompt that includes a pair of summarized text segments, corresponding metadata for the pair of summarized text segments, and that requests generation of a semantic similarity measure based on the pair of summarized text segments and based on the corresponding metadata. For instance, the prompt can be of the form “generate a semantic similarity measure, to two decimal points, between the following two text segments and with 1 being most similar and 0 being least similar; take into account similarity between the text and similarity between the metadata for the text: [text of first summarized text segment]; [text of second summarized text segment]; [first metadata for first summarized text segment]; [second metadata for second summarized text segment]”. The system can then process such a prompt using a machine learning model to generate the semantic similarity measure.

At block 208, the system updates a graph based on at least the semantic similarity measure generated at block 206. Block 208 can include sub-block 208A in which the system adds, to the graph and if not already included in the graph, node(s) for summarized text segment(s)of the pair. For example, if a node is not already included in the graph for a summarized text segment of the pair, the system can generate a new node for that summarized text segment. The node can include (e.g., incorporate or include pointer(s) to) the summarized text segment and, optionally, a corresponding raw text segment and/or metadata for the corresponding raw text segment.

Block 208 further includes sub-block 208B in which the system defines an edge between the nodes corresponding to summarized text segments of the pair and assigns the semantic similarity measure, of an iteration of block 206 for the pair, to that edge. For example, if nodes are already included in the graph for the summarized text segments of the pair, the system can define a new edge between those nodes where the new edge reflects the similarity measure generated at block 206 for the pair. If a node is not already included in the graph for one or both of the summarized text segments of the pair, the system can, at sub-block 208A, generate a new node for each summarized text segment of the pair and can, at block 208B, generate an edge between those two new nodes where the edge(s) reflect the similarity measure generated at block 206 for the pair. Through multiple iterations of block 208, a robust graph is generated that includes nodes corresponding to each summarized text segment generated at block 202 and edges that reflect respective semantic similarity measures of pairs of summarized text segments.

At block 210, the system determines whether all pairs of summarized text segments, of the summarized text segments generated at block 202, have been processed in an iteration of block 206. If the system determines that not all pairs of summarized text segments have been processed, the system returns to block 206 and processes another pair of summarized text segments. If the system determines that all pairs of summarized text segments have been processed, the system performs another iteration of block 210, optionally after a pause. For example, the system may wait for one minute, one hour, or another amount of time to pass before performing another iteration of block 210 to determine whether new pairs of summarized text segments need to be processed, such as pairs that include at least one recently generated summarized text segment.

At block 212, the system processes the graph to determine whether one or more clusters of semantic similarity measures exist. For example, the system can utilize a graph clustering algorithm or other graph analysis technique to determine whether there is a set of nodes (within the graph generated at block 208) that are grouped together in a cluster. As one example, the system can utilize an affinity propagation algorithm, an EM algorithm, or other graph clustering algorithm to determine whether one or more clusters of nodes exist in the graph generated at block 208. The system can perform block 212 at regular or non-regular intervals, when a new graph is generated, when a threshold number of new node(s) and/or edge(s) are added to the graph, and/or based on other criteria.

At block 214, the system processes the cluster(s), if any, determined at block 212, to determine one or more particularized actions to cause to be performed. For example, the system can determine a particularized action to be performed based on the summarized text segments corresponding to the nodes included in a cluster and/or based on the metadata corresponding to the summarized text segments corresponding to the nodes included in the cluster. As one example, the system can, for a cluster, generate a prompt based on the summarized text segments corresponding to the nodes included in a cluster and/or based on the metadata corresponding to the summarized text segments corresponding to the nodes included in the cluster, process that prompt using a generative model to generate output that reflects a summary of the problem(s) that are reflected by the cluster, and determine one or more particularized actions to cause performance of based on output generated by processing the prompt using the generative model. As another example, the system can process a prompt that is of the form “generate a summary of the problem(s) that are reflected by the following set of text segments and their related metadata: [text segments of this cluster]; [metadata related to text segments of this cluster]”. The system can cause the prompt to be processed using a generative model to generate output that reflects a summary of the problem(s) that are reflected by the cluster.

At block 216, the system causes the particularized action(s) determined at block 214 to be performed. For example, the system can communicate with one or more external devices and/or one or more external programs over the network to cause performance of the action(s) determined at block 214. For instance the system can send, over the network, instructions to cause the generation of one or more messages, the transmission of one or more messages, and/or the performance of one or more other automated action(s).

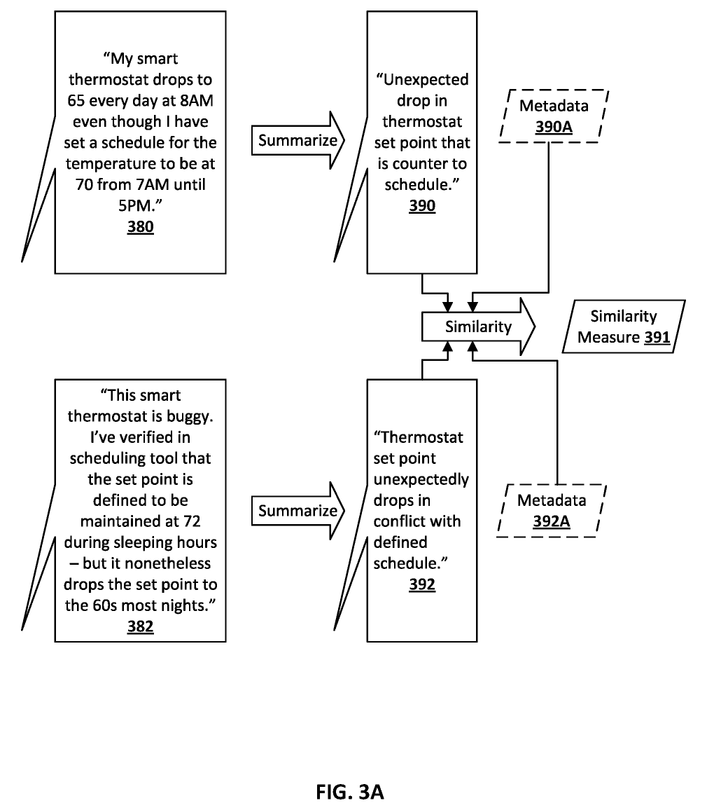

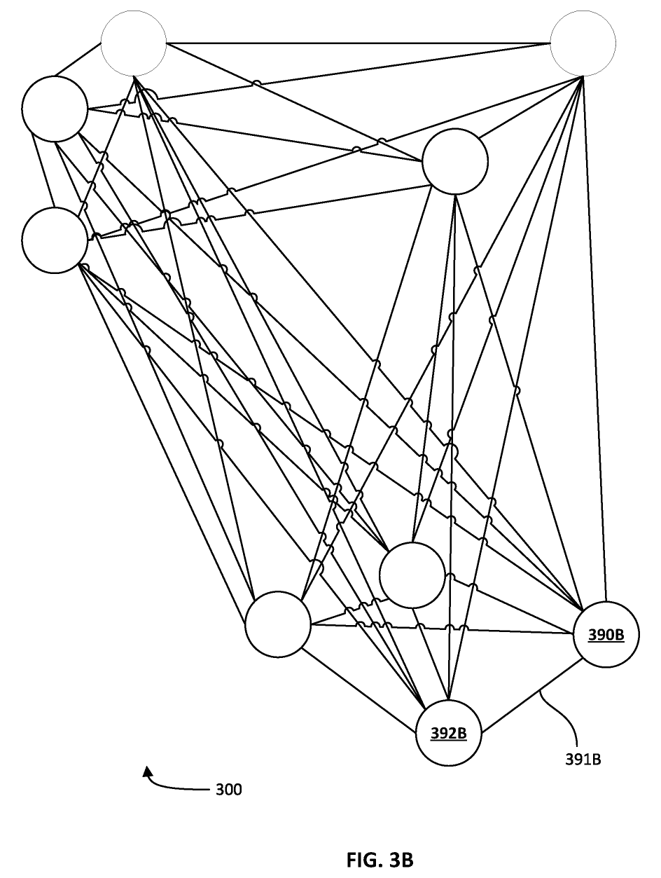

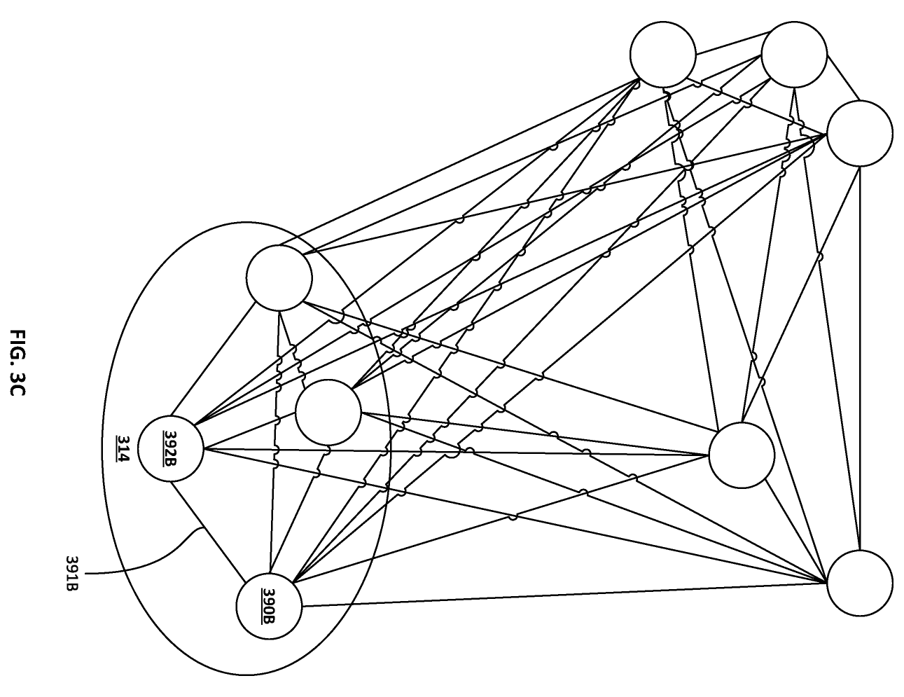

Turning now to FIGS. 3A, 3B and 3C, a non-limiting example of selected aspects of the present disclosure is illustrated.

FIG. 3A illustrates a first text segment 380 that is an instance of feedback provided for a smart thermostat application and a second text segment that is a separate instance of feedback provided for the smart thermostat application. The first text segment 380 is processed to generate a first summarized text segment 390 as illustrated in FIG. 3A and the second text segment 382 is likewise processed to generate a second summarized text segment 392 as illustrated in FIG. 3A. For example, the system can generate the first summarized text segment 390 by processing the first text segment 380 using a generative model and can likewise generate the second summarized text segment 392 by processing the second text segment 382 using the generative model.

The first and second summarized text segments 390, 392 can be processed to generate a similarity measure 391 that reflects a degree of semantic similarity between the first and second summarized text segments 390, 392 as illustrated in FIG. 3A. For example, the similarity measure 391 can be generated based on processing the first and second summarized text segments 390, 392 using a generative model. In some implementations, and as also illustrated in FIG. 3A, the similarity measure 391 that is generated can be further based on first metadata 390A corresponding to the first text segment 380 / the first summarized text segment 390 and second metadata 392A corresponding to the second text segment 382 / the second summarized text segment 392. For example, the similarity measure 391 can be generated based on generating a similarity prompt that includes the first and second summarized text segments 390, 392, the first and second metadata 390A, 392A, and that requests generation of a similarity measure 391 based on processing the first and second summarized text segments 390, 392, the first and second metadata 390A, 392A, and the similarity prompt. The similarity prompt can be processed using a generative model to generate output that reflects the similarity measure 391. As another example, an initial similarity measure can be generated based on processing the first and second summarized text segments 390, 392 using a machine learning model and the initial similarity measure can be boosted or demoted, based on the first and second metadata 390A, 392A, to generate the similarity measure 391.

FIG. 3B illustrates part 300 of a graph that is generated according to implementations disclosed herein. The graph includes an edge 391B that is generated based on (e.g., has a weight conforming to) the similarity measure 391 and that is between a first node 390B that corresponds to the first summarized text segment 390 and a second node 392B that corresponds to the second summarized text segment 392. The part 300 of the graph further includes additional nodes that correspond to other summarized text segments and additional edges that reflect semantic similarity measures between those summarized text segments.

FIG. 3C illustrates an example cluster 314 that includes nodes 390B and 392B as well as additional nodes included in the part 300 of the graph. The cluster 314 can be determine utilizing one or more clustering algorithms such as an affinity propagation algorithm, an EM clustering algorithm, and/or other graph clustering algorithm.

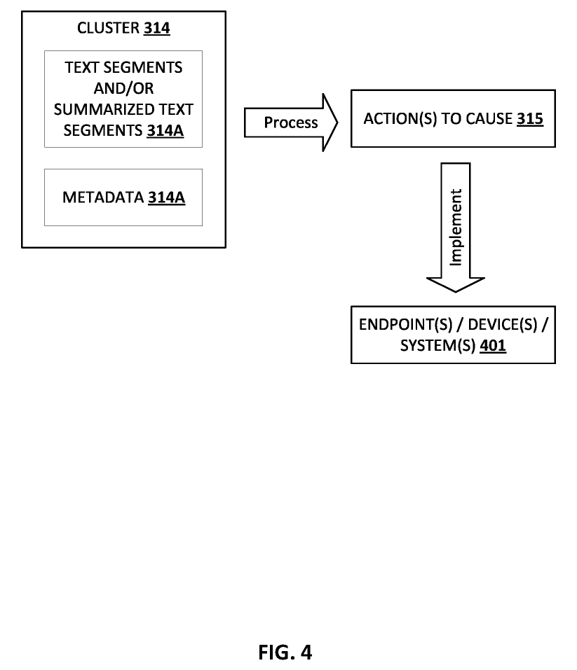

FIG. 4 depicts an example of processing data, related to a determined cluster, in determining automated action(s) to cause performance of. In FIG. 4, the cluster 314 (FIG. 3C) is illustrated as including text segments and/or summarized text segments 314A that correspond to nodes of the cluster 314 and metadata 314B that corresponds to the text segments and/or summarized text segments 314A included in the cluster 314. The cluster 314 is processed to determine actions to cause 315 and those actions are caused to be implemented at one or more endpoint(s), device(s), and/or system(s) 401. For example, a prompt can be generated that includes the text segments and/or summarized text segments 314A and the metadata 314B. Further, such a prompt can be processed, using a generative model, to generate output that reflects the action(s) to cause 315. For example, the output can reflect a summary of problem(s) associated with the cluster 314 and those problem(s) can be included in message(s) to be transmitted to endpoint(s) and/or those problem(s) can be utilized to determine endpoint(s) to which message(s) are to be transmitted.

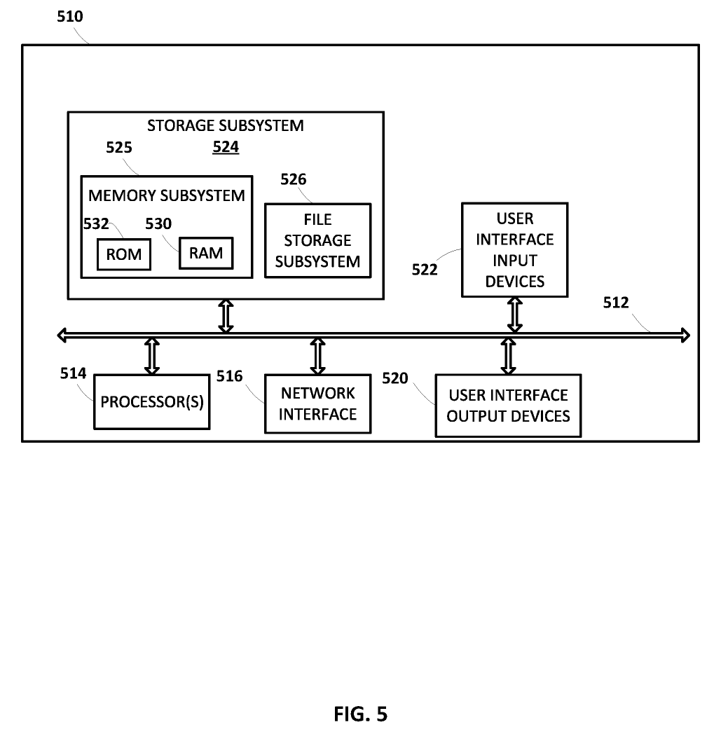

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to perform selected aspects of method 200. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a CD-ROM drive, an optical drive, or removable media cartridges. Modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple buses.

Computer system 510 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

In some implementations, a method implemented by processor(s) is provided and includes processing, using a machine learning model, a first text segment to generate a summarized first text segment that is semantically similar to the first text segment and that is shortened relative to the first text segment. The method further includes processing, using the machine learning model, a second text segment to generate a summarized second text segment that is semantically similar to the second text segment and that is shortened relative to the second text segment. The method further includes processing, using the machine learning model or an additional machine learning model, both the summarized first text segment and the summarized second text segment to generate a semantic similarity measure that reflects a magnitude of semantic similarity between the summarized first text segment and the summarized second text segment. The method further includes determining, based on the semantic similarity measure, that a cluster of summarized text segments is formed by the summarized first text segment, the summarized second text segment, and additional summarized text segments. The method further includes, in response to determining that the cluster of summarized text segments is formed, causing performance of one or more automated actions that are based on the cluster.

These and other implementations of the technology disclosed herein can optionally include one or more of the following features.

In some implementations, the machine learning model can be a generative model. In some of those implementations, processing the first text segment to generate the summarized first text segment can include processing, using the machine learning model, a first prompt that includes the first text segment and instructional language that requests summarization to a given length. In some of those implementations, processing the second text segment to generate the summarized second text segment can include processing, using the machine learning model, a second prompt that includes the second text segment and the instructional language that requests summarization to the given length.

In some implementations, the machine learning model can be a generative model. In some of those implementations, processing the first text segment to generate the summarized first text segment can include processing, using the machine learning model, a first prompt that includes the first text segment and instructional language that requests summarization in a given voice. In some of those implementations, processing the second text segment to generate the summarized second text segment can include processing, using the machine learning model, a second prompt that includes the second text segment and the instructional language that requests summarization in the given voice.

In some implementations, the machine learning model can be a generative model and the generative model can be fine-tuned to generate a summarization, of a processed text segment, that can be of a given length.

In some implementations, the machine learning model can be a generative model and the generative model can be fine-tuned to generate a summarization, of a processed text segment, that can be of a given voice.

In some implementations, processing both the summarized first text segment and the summarized second text segment to generate the semantic similarity measure can include processing, using the generative model or the additional generative model, a similarity prompt that includes the summarized first text segment, the summarized second text segment, and instructional language that requests generation of output that reflects the magnitude of semantic similarity between the summarized first text segment and the summarized second text segment.

In some versions of those implementations, the prompt can further include first metadata that can be correlated to a first submission of the first text segment, second metadata that can be correlated to a second submission of the second text segment, and the instruction language can request that the magnitude of semantic similarity takes into account the first metadata and the second metadata.

In some versions of those implementations, the first metadata can reflect a temporal attribute of submission of the first text segment by a client device, a geographical attribute of the client device, and/or a version of an application executed by the client device.

In some implementations, the semantic similarity measure can be generated further based on first metadata that can be correlated to a first submission of the first text segment and second metadata that can be correlated to a second submission of the second text segment.

In some implementations, the method can further include, in response to determining that the cluster of summarized text segments is formed, processing, using the generative model, the additional generative model, or a further generative model, the summarized text segments of the cluster to generate an overall summary of the cluster. In some of those implementations, causing performance of the one or more automated actions that can be based on the cluster can include causing performance of the one or more automated actions based on the overall summary of the cluster. In some versions of those implementations, causing performance of the one or more automated actions based on the overall summary can include transmitting, to one or more endpoints, a message that includes the overall summary. In some versions of those implementations, causing performance of the one or more automated actions based on the overall summary can include selecting one or more endpoints based on the overall summary; and transmitting one or more messages to the selected one or more endpoints. In some versions of those implementations, causing performance of the one or more automated actions based on the overall summary can include disabling a feature of an application, rolling back an update to the application, and/or halting further rollout of the update to the application. In some versions of those implementations, the method can further include processing corresponding metadata, for each of the summarized text segments, in generating the overall summary of the cluster.

In some implementations, the method can further include generating, in a graph, an edge that reflects the semantic similarity measure and that is between a first node that corresponds to the first text segment and a second node that corresponds to the second segment. In some of those implementations, determining, based on the semantic similarity measure, that the cluster of summarized text segments is formed by the summarized first text segment, the summarized second text segment, and the additional summarized text segments, can include determining that the cluster is formed based on processing of the edge and of additional edges, the additional edges being between additional pairs of nodes corresponding to the summarized text segments of the cluster. In some versions of those implementations, the additional edges can include a first additional edge between the first node and a third node that corresponds to a third summarized text segment of the additional summarized text segments of the cluster, a second additional edge between the second node and the third node, and a fourth additional edge between the third node and a fourth node that corresponds to a fourth summarized text segment of the additional summarized text segments of the cluster.

In some implementations, the first text segment can be feedback directed to an application and that can be provided via a first client device, the second text segment can be feedback directed to the application and that can be provided via a second client device, and processing the first text segment and processing the second text segment to generate the semantic similarity measure can be responsive to them both being feedback directed to the application.

Some implementations include a transitory or non-transitory computer readable storage medium storing instructions executable by processor(s) (e.g., central processing unit(s) (CPU(s)), graphics processing unit(s) (GPU(s)), and/or other processor(s)) to perform a method such as one or more of the methods described herein. Some implementations include a system including memory and one or more processors operable to execute instructions, stored in the memory, to implement one or more modules or engines that, alone or collectively, perform a method such as one or more of the methods described herein.

What is claimed is:

1. A method implemented by one or more processors, the method comprising:
processing, using a machine learning model, a first text segment to generate a summarized first text segment that is semantically similar to the first text segment and that is shortened relative to the first text segment;
processing, using the machine learning model, a second text segment to generate a summarized second text segment that is semantically similar to the second text segment and that is shortened relative to the second text segment;
processing, using the machine learning model or an additional machine learning model, both the summarized first text segment and the summarized second text segment to generate a semantic similarity measure that reflects a magnitude of semantic similarity between the summarized first text segment and the summarized second text segment;
determining, based on the semantic similarity measure, that a cluster of summarized text segments is formed by the summarized first text segment, the summarized second text segment, and additional summarized text segments; and
in response to determining that the cluster of summarized text segments is formed:
causing performance of one or more automated actions that are based on the cluster.

2. The method of claim 1, wherein the machine learning model is a generative model and wherein:
processing the first text segment to generate the summarized first text segment comprises processing, using the machine learning model, a first prompt that includes the first text segment and instructional language that requests summarization to a given length; and
processing the second text segment to generate the summarized second text segment comprises processing, using the machine learning model, a second prompt that includes the second text segment and the instructional language that requests summarization to the given length.

3. The method of claim 1, wherein the machine learning model is a generative model and wherein:
processing the first text segment to generate the summarized first text segment comprises processing, using the machine learning model, a first prompt that includes the first text segment and instructional language that requests summarization in a given voice; and
processing the second text segment to generate the summarized second text segment comprises processing, using the machine learning model, a second prompt that includes the second text segment and the instructional language that requests summarization in the given voice.

4. The method of claim 1, wherein the machine learning model is a generative model and wherein the generative model is fine-tuned to generate a summarization, of a processed text segment, that is of a given length.

5. The method of claim 1, wherein the machine learning model is a generative model and wherein the generative model is fine-tuned to generate a summarization, of a processed text segment, that is of a given voice.

6. The method of claim 1, wherein processing both the summarized first text segment and the summarized second text segment to generate the semantic similarity measure comprises:
processing, using the generative model or the additional generative model, a similarity prompt that includes the summarized first text segment, the summarized second text segment, and instructional language that requests generation of output that reflects the magnitude of semantic similarity between the summarized first text segment and the summarized second text segment.

7. The method of claim 6, wherein the prompt further includes first metadata that is correlated to a first submission of the first text segment, second metadata that is correlated to a second submission of the second text segment, and wherein the instruction language requests that the magnitude of semantic similarity takes into account the first metadata and the second metadata.

8. The method of claim 7, wherein the first metadata reflects a temporal attribute of submission of the first text segment by a client device, a geographical attribute of the client device, and/or a version of an application executed by the client device.

9. The method of claim 1 wherein the semantic similarity measure is generated further based on first metadata that is correlated to a first submission of the first text segment and second metadata that is correlated to a second submission of the second text segment.

10. The method of claim 1, further comprising, in response to determining that the cluster of summarized text segments is formed:
processing, using the generative model, the additional generative model, or a further generative model, the summarized text segments of the cluster to generate an overall summary of the cluster;
wherein causing performance of the one or more automated actions that are based on the cluster comprises causing performance of the one or more automated actions based on the overall summary of the cluster.

11. The method of claim 10, wherein causing performance of the one or more automated actions based on the overall summary comprises transmitting, to one or more endpoints, a message that includes the overall summary.

12. The method of claim 10, wherein causing performance of the one or more automated actions based on the overall summary comprises:
selecting one or more endpoints based on the overall summary; and
transmitting one or more messages to the selected one or more endpoints.

13. The method of claim 10, wherein causing performance of the one or more automated actions based on the overall summary comprises:
disabling a feature of an application,
rolling back an update to the application, and/or
halting further rollout of the update to the application.

14. The method of claim 10, further comprising:
processing corresponding metadata, for each of the summarized text segments, in generating the overall summary the cluster.

15. The method of claim 1, further comprising:
generating, in a graph, an edge that reflects the semantic similarity measure and that is between a first node that corresponds to the first text segment and a second node that corresponds to the second segment;
wherein determining, based on the semantic similarity measure, that the cluster of summarized text segments is formed by the summarized first text segment, the summarized second text segment, and the additional summarized text segments, comprises:
determining that the cluster is formed based on processing of the edge and of additional edges, the additional edges being between additional pairs of nodes corresponding to the summarized text segments of the cluster.

16. The method of claim 15, wherein the additional edges include a first additional edge between the first node and a third node that corresponds to a third summarized text segment of the additional summarized text segments of the cluster, a second additional edge between the second node and the third node, and a fourth additional edge between the third node and a fourth node that corresponds to a fourth summarized text segment of the additional summarized text segments of the cluster.

17. The method of claim 1, wherein the first text segment is feedback directed to an application and that is provided via a first client device, the second text segment is feedback directed to the application and that is provided via a second client device, and wherein processing the first text segment and processing the second text segment to generate the semantic similarity measure is responsive to them both being feedback directed to the application.

18. One or more non-transitory computer-readable storage media having program instructions collectively stored on the one or more computer-readable storage media, the program instructions executable to:
process, using a machine learning model, a first text segment to generate a summarized first text segment that is semantically similar to the first text segment and that is shortened relative to the first text segment;
process, using the machine learning model, a second text segment to generate a summarized second text segment that is semantically similar to the second text segment and that is shortened relative to the second text segment;
process, using the machine learning model or an additional machine learning model, both the summarized first text segment and the summarized second text segment to generate a semantic similarity measure that reflects a magnitude of semantic similarity between the summarized first text segment and the summarized second text segment;
determine, based on the semantic similarity measure, that a cluster of summarized text segments is formed by the summarized first text segment, the summarized second text segment, and additional summarized text segments; and
in response to determining that the cluster of summarized text segments is formed:
cause performance of one or more automated actions that are based on the cluster.

19. A system comprising:
memory storing instructions; and
one or more processors operable to execute the instructions to:
process, using a machine learning model, a first text segment to generate a summarized first text segment that is semantically similar to the first text segment and that is shortened relative to the first text segment;
process, using the machine learning model, a second text segment to generate a summarized second text segment that is semantically similar to the second text segment and that is shortened relative to the second text segment;
process, using the machine learning model or an additional machine learning model, both the summarized first text segment and the summarized second text segment to generate a semantic similarity measure that reflects a magnitude of semantic similarity between the summarized first text segment and the summarized second text segment;
determine, based on the semantic similarity measure, that a cluster of summarized text segments is formed by the summarized first text segment, the summarized second text segment, and additional summarized text segments; and
in response to determining that the cluster of summarized text segments is formed:
perform one or more automated actions that are based on the cluster.
